(19) United States
(12) Patent Application Publication
(10) Pub. No.: US 2020/0275671 A1
(43) Pub. Date: Sep. 3, 2020

(54) METHOD AND REEFER CONTAINER, TRUCK OR TRAILER FOR RIPENING OF VEGETABLE PRODUCE IN A CONTROLLED ATMOSPHERE

(71) Applicant: MAERSK CONTAINER INDUSTRY A/S, Tinglev (DK)

(72) Inventors: Anders Gamborg HOLM, Kolding (DK); Morten Klose, Grenaa (DK); Poul Kim MADSEN, Loegumkloster (DK); Niels Nielsen POULSEN, Vojens (DK)

(73) Assignee: MAERSK CONTAINER INDUSTRY A/S, Tinglev (DK)

(21) Appl. No.: 16/763,646

(22) PCT Filed: Nov. 14, 2018
(86) PCT No.: PCT/EP2018/081227

§ 371 Date: May 13, 2020

(30) Foreign Application Priority Data
Nov. 15, 2017 (DK) PA 2017 70862

(51) Int. Cl. A23B 7/152; A23B 7/04

(52) U.S. Cl. CPC A23B 7/152; A23V 2002/00; A23B 7/04

(57) ABSTRACT

The present invention relates to a method of ripening perishable products during transport in a structure including a controlled atmosphere system, which method provides variable ripening time by changing temperature in the structure from a temperature where ripenable produce are kept in an unripening controlled atmosphere to a temperature where the ripenable products ripens in controlled atmosphere. The present invention further relates to a structure for shipping perishable products such as fruit and vegetables, which structure includes a controlled atmosphere system including sensors capable of measuring at least one of following parameters: temperature, O₂ or CO₂; a dosing mechanism for dosing ripening agent; and a ripening process controller, which controller controls the ripening process based on sensed values of temperature, O₂ and/or CO₂.

The invention relates to a method of ripening perishable products during transport in a reefer container or a refrigerated truck or trailer, each refrigerated loadspace comprising a controlled atmosphere system, which method provides variable ripening time.

The invention further relates to a reefer container or a refrigerated truck or trailer for shipping perishable products such as fruit and vegetables, which container, truck or trailer comprises:
a controlled atmosphere system including sensors capable of measuring at least one of following parameters: temperature, O₂ or CO₂.

Ripenable produce are often transported overseas in ships and reefer containers. Keeping the ripenable produce at a temperature controlled atmosphere prevents ripening of the produce. Over shorter distances ripenable produce can be transported by a refrigerated truck or trailer.

One example of a ripenable produce can be bananas. When a shipment of bananas has reached its destination, the bananas must be ripened in a warehouse for a period of time. After the bananas have spent time in the ripening warehouse, the bananas can be distributed to the marketplaces/distribution centres with acceptable ripeness.

To determine the ripening stage of the bananas a 7 stage classification of banana ripening can be used. Stage 1 is all green bananas, stage 2 is green with trace of yellow, stage 3 is more green than yellow, stage 4 is more yellow than green, stage 5 is yellow with green tips and necks, stage 6 is all yellow and stage 7 is all yellow with brown flecks. Previously the bananas would be received off the ship at stage 1—all green and following ripened in a ripening warehouse.

Another example of such a ripenable produce can be avocados, plums or mangos.

Further examples of ripenable produces can be fruits, vegetables. In fact most produce having a kind of respiration and which are adaptable for lowered respiration rate, can be transported in this way.

It is therefore advantageous if the ripening process can be controlled during shipment in such a way that the produce can be distributed to distribution centres or even to supermarkets in a sufficient ripened state.

Different solutions exist in relation to containers in respect of controlled atmosphere and ripening produce, but common for these solutions are that they are inefficient and often do not carefully control the ripening process.

In general the sum proportion of carbon dioxide and oxygen in a container will always remain approximately 21% unless the composition of either the outgoing and/or ingoing air is actively and effectively manipulated to thereby change this sum proportion (of 21%) as necessary.

A system capable of such change of sum proportion is a controlled atmosphere system.

The problem identified is that once the ripening process has been initiated in the containers, there is limited control of the ripening process. Currently the ripening process will start by raising the temperature of the bananas to around 18° C. and the atmosphere will be dosed with ethylene to 100 PPM.

Again taking bananas as an example, during the ripening process an issue is that once the bananas start ripening, they give off a significant amount of heat. At peak ripening bananas produce a heat of 300 W/ton or more. Allowing the bananas to ripen without careful control in the container means that large fans are needed to remove the heat generated from ripening and to extract the heat from the container.

Bananas ripen differently depending on the variety, ripening stage and conditions. In ripening warehouses the bananas are manually inspected and sorted as the bananas ripen at different rates. Current container processes do not allow for even ripening throughout the container. This means that there can be some spoiled bananas in the container even when there are other bananas which are unripe.

WO 95/00030 A1 discloses a system for ripening of for example bananas during transport where it is possible to ripen bananas to a ripening stage sufficient to transport the load directly to a retail distribution destination without a need for a usual stop off at a ripening facility. Here also the problem of sufficient refrigeration capacity to handle the heat load resulting within the container due to the ripening process is mentioned.

To avoid so called hot spots within the container, a solution have been to ship less than a full container, hereby providing additional space between load piles to ensure sufficient air circulation and hereby lowering the temperature or keeping the temperature within the container low.

This is not corresponding to the desire of transporting as much load in the container as possible.

In conclusion, when ripening produce in containers it is difficult to avoid hotspots in the produce and it is difficult to obtain uniform ripening of the produce and it is an object of the present invention to solve this problem.

In order to be capable of ripening produce within a reefer container or a refrigerated truck or trailer using controlled atmosphere, it is important that the produce to be ripened is one produce per transportable refrigerated loadspace only or loaded produce having same ripening properties. Otherwise it is extremely difficult to control the ripening process by adjusting parameters such as content of O₂, CO₂, ethylene, propylene, acetylene and the temperature.

In the following the invention is explained in relation to a reefer container with a controlled atmosphere system, but as indicated above also a refrigerated truck or trailer having a controlled atmosphere system can be used. When the word container is used it should be understood as a reefer container having a controlled atmosphere system.

One object of the invention is to carefully control the ripening process, so that the ripening produce can arrive to a marketplace/distribution centre at a ripening stage desired by the customer.

Consequently it is possible by the invention further to carefully control the ripening process, so that the ripening produce arrive at a stage close to fully ripened, but not fully ripened.

If the produce is for example bananas, the aim is to let them arrive to a marketplace/distribution centre at stage 2-3. This means that the shipment of bananas can be distributed directly from the ship, truck or trailer to the marketplace/distribution centres. In other words: by controlling of the ripening process in transit it is possible to use the transit time to ripen the bananas as well. This means that the bananas can get to the marketplace quicker and directly from shipment.

Hereby it is possible to lower the cost of ripening because ripening in current ripening rooms and warehouses can be saved. Each container can be individually controlled to ripen at the right time. Since the produce do not have to go to the ripening warehouse, the transport route is shorter and total delivery time is shorter.

Another object of the invention is to detect when produce to be ripened is in different stages of a CO₂ production curve and control the conditions of the container to manage the produce ripening. The CO₂ production curve is shown in FIG. 2 and is a clear indication of ripening. The ripening curve shows that the measurement of CO₂ is being used to detect where in the ripening curve the current shipment of bananas are.

This can be achieved by the invention by a method of ripening perishable products during transport in a reefer container or a refrigerated truck or trailer, each comprising a controlled atmosphere system, which method provides variable ripening time by following steps comprising:
establishing a controlled atmosphere within the container, truck or trailer with ripenable produce loaded;
changing temperature in the container, truck or trailer from a temperature where ripenable produce are kept in an unripening controlled atmosphere to a temperature where the ripenable products ripens in controlled atmosphere;
dosing ripening agent to the controlled atmosphere in order to initiate ripening while maintaining controlled atmosphere;
check if ripening rate is increasing or decreasing and determine ripening status of products by measuring CO₂ respiration rate;
when CO₂ respiration rate is rising a ripening model is calibrated using input of timing for ripening start based on scheduled delivery;
when a predetermined ripening stage is achieved, the temperature is changed to transport temperature for the ripenable produce; and
products are maintained at predetermined ripening state under controlled atmosphere conditions.

Respiration rate can be expressed as a function of CO₂ production. When measuring CO₂ concentration, the measuring is carried out inside the container by a CO₂ sensor.

The CO₂ production in normal cubic meters per hour can be expressed as (CO₂ concentration (CO₂ %) in the container)×(ventilation rate in normal cubic meters per hour) equal to (mass of cargo/produce (bill of loading))×(specific respiration (ml CO₂ per kg per hour).

When ripening is started it cannot be stopped. It can be slowed down, but not stopped.

It is therefore important to initiate or start ripening at a time where there is time enough to ripen the produce to a certain stage before delivery and at a time not too long before delivery so over ripening is avoided.

When a customer orders a shipment of produce, for example bananas, it is determined which ripening stage a load of bananas within one reefer container, refrigerated truck or trailer should have, when delivered. As an example a load from one reefer container can be ordered as light green bananas which ripening stage allows for storage at the store before selling (or selling at a still early ripening stage) and another load at a stage where the load consist of half green, half yellow bananas ready to be sold.

Timing of ripening start based on scheduled delivery should therefore be understood as a point of time during transport or storage of produce in a reefer container, refrigerated truck or trailer, where remaining time before delivery corresponds to ripening to the ripening stage of the produce ordered by the customer.

Ripenable produce of climacteric type, for example a banana, picked at a given ripened stage, has a given percentage of starch that can be converted to sugar during the ripening process. The final ripening is to activate the process of conversion of starch to sugar to a desired level ready for sale.

The conversion process need a given amount of energy per kilogram starch to be converted, which amount of energy is equivalent to a given amount of produced kg CO₂/kg ripenable produce.

Ripening stage of bananas can be evaluated on basis of a degree of yellowness, being an indirect measure for how sweet the banana is—which again can be expressed as how much of the starch that is converted to soluble sugars (glucose, fructose).

During this conversion process from starch to sugar, heat (and thereby CO₂) is released—there is a correlation between how the percentage of conversion of starch to sugar and the specific accumulated CO₂ production per mass unit of ripenable produce.

Using bananas as an example a ripening index can be identified as a banana's colour. The colour can be measured by one or more sensors. The ripening speed can then be expressed as a colour change per time unit. Colour change can then be input for regulation of O₂ and thereby regulating the speed of ripening.

Even though scheduled delivery has been agreed upon, circumstances such a bad weather can influence on time of delivery. When scheduled time of delivery is changed, the ripening of the produce can be adjusted to meet ripeness at re-scheduled time of delivery.

According to one embodiment of the method the O₂ content in the container is increased from controlled atmosphere level to 5-21%, preferably 7-10%, before injection of ripening agent.

According to one embodiment of the method the O₂ content in the container is increased for a period of 12-48 hrs. after injection of ripening agent.

According to one embodiment of the method the ripening is started at a predetermined time before scheduled ripening finalization.

Scheduled ripening finalization should be understood as the time where the produce has reached a determined (ordered) ripening stage.

According to one embodiment of the method, the controlled atmosphere has an O₂ content of 1-10% and a CO₂ content of 0-10%.

According to one embodiment of the method the controlled atmosphere has an O₂ content of 2-5% and a CO₂ content of 3-7%.

According to one embodiment the ripening stage is defined from accumulated CO₂ production (or O₂ consumption) per mass unit of ripenable produce during the ripening process.

According to one embodiment of the method, the specific heat production from the ripenable produce is kept below 300 Watt/ton by controlling the atmosphere within the container, truck or trailer in relation to O₂, CO₂, ripening agent concentration and/or temperature. In another embodiment the specific heat production from the ripenable produce is kept below 200 Watt/ton also by controlling the atmosphere within the container, truck or trailer in relation to O₂, CO₂, ripening agent concentration and/or temperature.

The controlled atmosphere system in the reefer container, refrigerated truck or trailer can hereby adjust speed of ripening of the produce, once the ripening is started, by adjusting one or more of following parameters: O₂, CO₂, ripening agent concentration and/or temperature.

According to one embodiment of the method, the ripening process is controlled on basis of correlations of ripening time, temperature, O₂, CO₂, and ripening agent dosing.

According to one embodiment of the method, the ripening process speed is controlled by regulating the O₂ content inside the container atmosphere to achieve a specific CO₂ production or O₂ consumption per mas unit of ripenable produce.

According to one embodiment of the method, the ripening stage is defined from accumulated CO₂ production (or O₂ consumption) per mass unit of ripenable produce during the ripening process.

According to one embodiment of the method, the ripening process is calibrated by input from the time and ripening correlation between maximum respiration rate corresponding to type of ripenable produce and ripening stage of ripenable produce in the container, truck or trailer at that time.

According to one embodiment of the method, the ripening stage is monitored using an electronic colour sensor, meassuring colours within an infrared spectrum.

According to one embodiment of the method, an amount of chlorophyll and/or amount of beta carotene is meassured using an electronic colour sensor.

According to one embodiment of the method, the ripening process is calibrated and/or started when measured CO₂ respiration rate from the ripenable produce reaches a stable signal.

In order to achieve a stable signal, actual CO₂ respiration rate is evaluated against a moving average of CO₂ respiration rate in an interval of between 4 hours and 48 hours, preferably between 12 hours to 24 hours and exceeding two times a standard deviation calculated based on readings of CO₂ respiration measured within the last/preceding 12 hours.

When ripening agent is injected and a stable signal for increased respiration rate is detected within the above time intervals and when exceeding two times a standard deviation, the ripening model is calibrated where an accumulated measuring of CO₂ respiration is started as an integral of the separate ripening model determining the ripening state of products or produce.

Counting of time is started when ripening agent is injected and the actual CO₂ respiration rate is evaluated against a moving average or rolling average of CO₂ respiration rate in an interval of between 4 hours and 48 hours, preferably between 12 hours to 24 hours and a standard deviation calculated based on readings of CO₂ respiration measured within the last/preceding 12 hours.

Hereby it is possible to adjust the rate of ripening in relation to remaining time to delivery.

According to one embodiment of the method, the ripening process is adjusted based on updated ripening finalization time or the ripenable produce are kept under maintained controlled atmosphere when a predetermined stage of ripening is achieved.

Hereby it is possible to adjust or slow down the rate of ripening in relation to remaining time to delivery.

As an example the stage of ripening can be monitored by use of an electronic colour sensor, meassuring colours within an infrared spectrum.

The colour sensor can as an example be an optical multi spectral sensor, which sensor can provide information such as amount of chlorophyll, water content, amount or intensity of red pigments.

In an embodiment an amount of chlorophyll and/or amount of beta carotene is meassured.

The meassurements are used as a feedback to the controller to adjust one or more of following parameters: O₂, CO₂, ripening agent concentration and/or temperature.

According to one embodiment of the method, the ripening agent is ethylene and/or propylene and/or acetylene.

It can also be achieved by the invention by a reefer container or a refrigerated truck or trailer for shipping perishable products such as fruit and vegetables, which container, truck or trailer comprises:
a controlled atmosphere system including sensors capable of measuring at least one of following parameters: temperature, O₂ or CO₂;
a dosing mechanism for dosing ripening agent; and
a ripening process controller, which controller controls the ripening process based on sensed values of temperature, O₂ and/or CO₂.

The ripening process controller is a hardware CPU connected to a memory.

According to one embodiment, the controlled atmosphere system comprises an electronic colour sensor.

According to one embodiment, the controlled atmosphere system comprises a dosing mechanism for dosing ripening agent.

According to one embodiment, the controlled atmosphere system comprises a dosing mechanism for a ripening agent receptor blocking agent.

An example of such a ripening agent receptor blocking agent can be 1-MCP.

According to one embodiment, the controlled atmosphere system comprises a ripening agent removal system comprising photo-catalytic destruction, destruction by ozone or absorption removal.

According to one embodiment, the ripening agent is ethylene and/or propylene and/or acetylene.

If the controller can determine where on the CO₂ production curve particular bananas are, then the ripening process can be controlled. The ripening process is a multifactor parameter process. At least CO₂, O₂, ethylene/propylene/acetylene and temperature all contribute to the ripening process. Once the controller determines where the bananas are on the CO₂ production curve, the controller can control the atmosphere and temperature of the container such that the bananas do not over ripen and arrive at their destination at the correct ripeness according to the customer's desire or specification.

In particular the process requires 1) maintaining a steady atmosphere and temperature state where there is no ripening, 2) initiating the ripening process by modifying/dosing the atmosphere and raising the temperature and 3) slowing the ripening process by reducing the temperature and modifying/purging the atmosphere.

The controller can be provided with a ripening baseline for a ripening model for a shipment of for example bananas. A ripening model can be modified based on the real-time sensor input from the container. This may be required because the amount of O₂, CO₂ and ethylene and temperature generated for each different shipment and container may be different. Therefore the ripening baseline model is calibrated to a particular banana shipment. Individual containers can be ripened according to the particular banana shipment requirements.

Consequently each ripenable produce will have a separate ripening model, which is to be provided for each container and a ripening baseline model can be calibrated to a particular produce shipment. Individual containers can hereby be ripened according to the particular produce shipment requirements.

Calibrated should in context of this application mean that when a certain CO₂ respiration rate is reached, an accumulated measuring of CO₂ respiration is started as an integral of the separate ripening model determining the ripening state of products or produce.

When ripenable produce is ripened in controlled atmosphere providing low O₂ and high CO₂ to lower the ripening rate, precise management of temperature within the container becomes much easier to manage.

Low O₂ will correspond to a content of O₂ in a range of 1-10%, preferably 2-5% and high CO₂ will correspond to a content of CO₂ in a range of 0-10%, preferably 3-7%.

Since the controller can control the rate of ripening, the process can be controlled depending on when the estimated time of arrival of the shipment. If the shipment is delayed, then the controller can delay the ripening process accordingly. The controller can be connected to a remote server. This means that the controller can receive ripening instructions remotely.

For example if the owner of the shipment needs bananas in a more ripen state than usual because ripen bananas are needed more quickly, a ripening command is sent to the controller earlier than usual. This would mean that the bananas would be received in a terminal yard riper than normal.

The controller can modify the ripening parameters of the controlled atmosphere in the container to be able to adjust the time of ripening and to avoid hotspots within the container.

One option to control the ripening according to an aspect of the invention is to determine the respiration rate and accumulated respiration of the exact produce transported.

Each kind of produce has a specific respiration curve based on mg CO₂ per kg fruit or vegetable per hour and elapsed time.

Such curves are loaded into the controller and during transport sensed values of CO₂ produced by respiration of the produce are compared to the curve values already in the controller.

The values can be described as an integral from Time_{ripening start} to Time_{ripening end} where the CO₂ produced by respiration of the produce corresponds to the area from Time_{ripening start} to Time_{ripening end} under the curve or graph.

In case of controller failure, the system is provided with a failsafe mode establishing a failsafe atmosphere within the container.

In this case the container atmosphere may be flood with O₂ and/or temperature will rise due to failure on refrigeration system. Ethylene blocking atmosphere may be used to control the ripening. An example of a ripening agent receptor blocking agent can be 1-MCP.

Additionally ethylene can be destroyed by passing the atmosphere through an ozone atmosphere or similar ethylene removal system.

Other examples of determining ripening state of produce can be a camera detecting colour change of the produce, one or more devices measuring sugar content of the produce and one or more devices measuring firmness of the produce.

The above and other features and advantages of the present invention will become readily apparent to those skilled in the art by the following detailed description of exemplary embodiments thereof with reference to the attached drawings, in which:

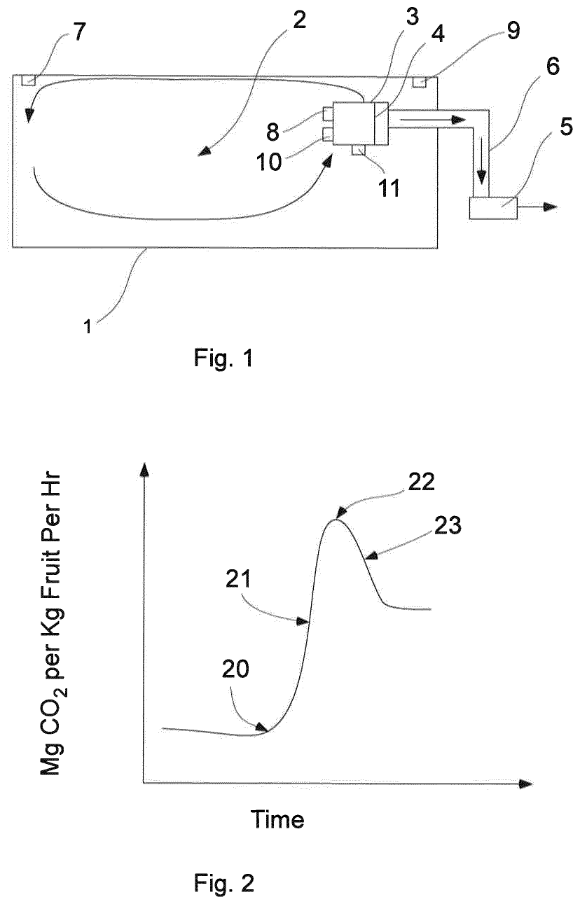

FIG. 1 shows a reefer container for shipping perishable products such as fruit and vegetables comprising equipment for establishing and maintaining a controlled atmosphere within the container;

FIG. 2 shows an example of a CO₂ production curve for a load of bananas within a container comprising controlled atmosphere;

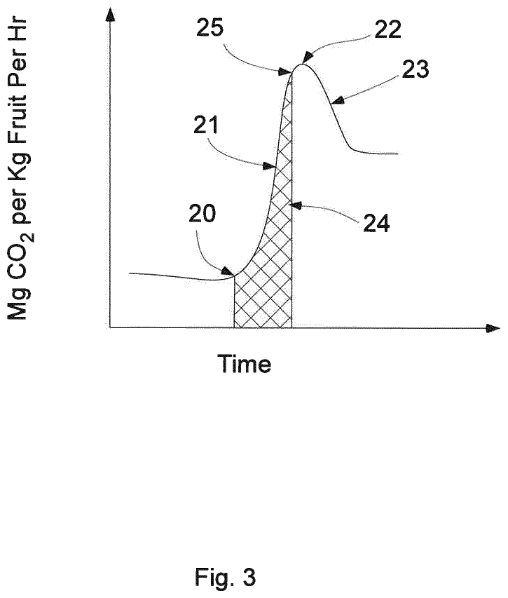

FIG. 3 is an example of a CO₂ production curve for a load of bananas, where showing accumulated measured CO₂ respiration rate from a ripenable produce in order to determine the stage of ripening within a container comprising controlled atmosphere;

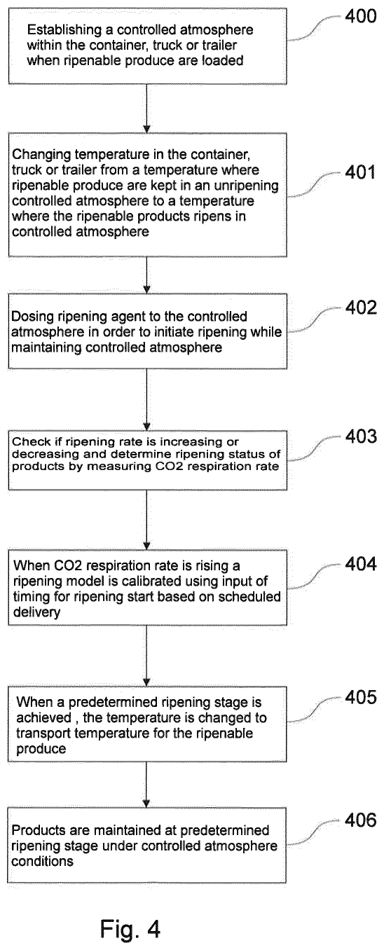

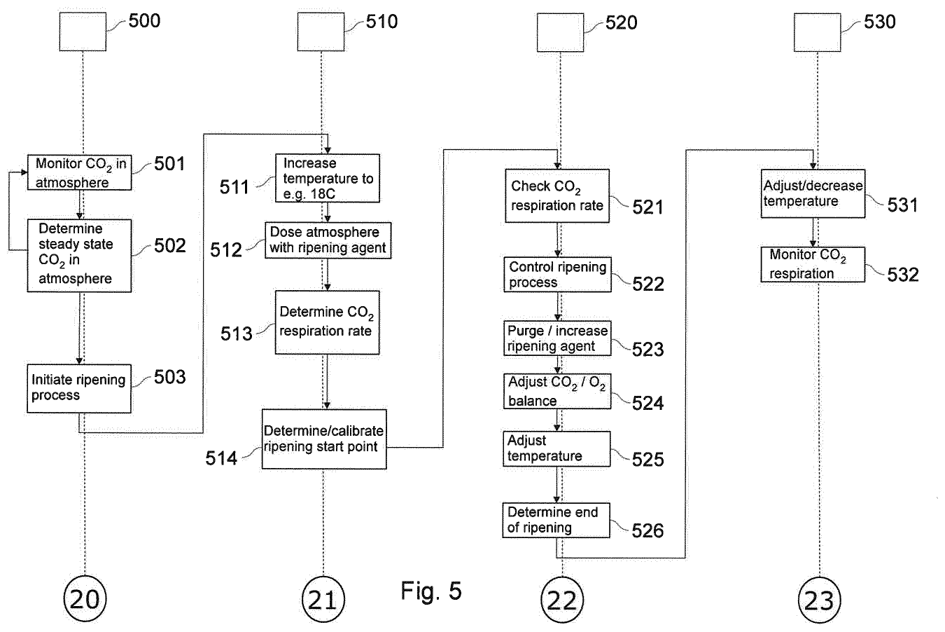

FIG. 4 shows a flow diagram providing steps of a method of ripening perishable products during transport in a reefer container or a refrigerated truck or trailer, each comprising a controlled atmosphere system, which method provides variable ripening time;

FIG. 5 shows a flow diagram for different ripening stages of a produce;

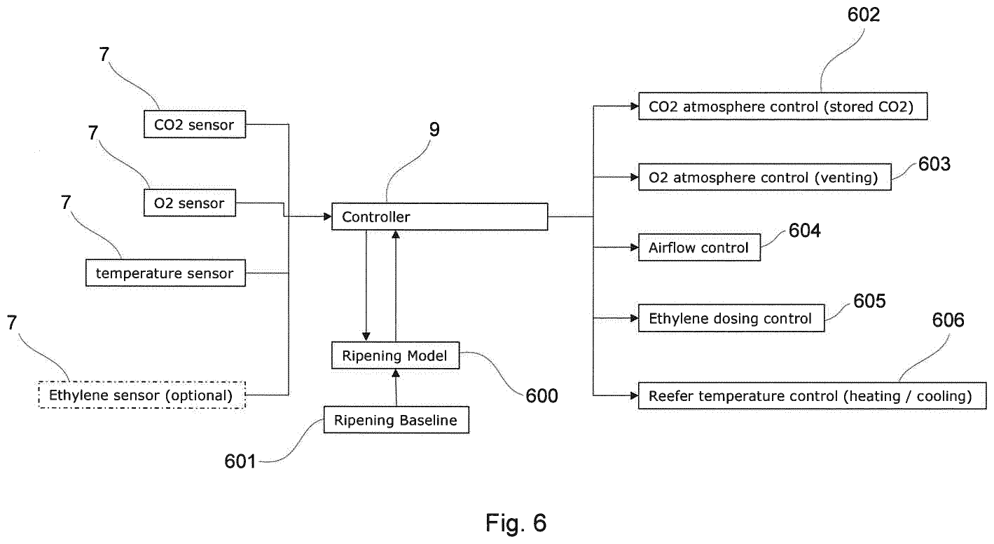

FIG. 6 shows a flow diagram illustrating signals to and from a hardware controller for controlling the process; and

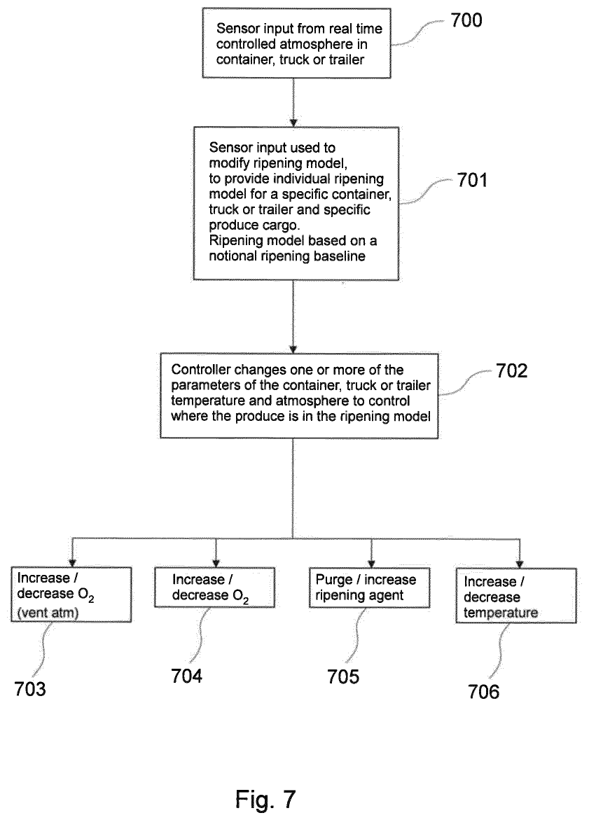

FIG. 7 shows a flow diagram illustrating steps in relation to a ripening model.

Various embodiments are described hereinafter with reference to the figures. Like reference numerals refer to like elements throughout. Like elements will, thus, not be described in detail with respect to the description of each figure.

It should also be noted that the figures are only intended to facilitate the description of the embodiments.

They are not intended as an exhaustive description of the claimed invention or as a limitation on the scope of the claimed invention. In addition, an illustrated embodiment needs not have all the aspects or advantages shown.

An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

In FIG. 1 is shown a reefer container 1 with a space 2 for shipping perishable products such as fruit and vegetables. The container 1 is provided with equipment 3 for establishing and maintaining a controlled atmosphere within the container 1. The controlled atmosphere is meant to establish an atmosphere within the container 1 having a content of O₂ in a range of 1-10%, preferably 2-5% and a content of CO₂ in a range of 010%, preferably 3-7%.

When ripening produce begins to produce CO₂, the controlled atmosphere system 3 by means of a pressure swing absorber or a membrane 4 can adjust the CO₂ content within the loadspace 2 of the container 1.

The controlled atmosphere system 3 can be provided with a pipe 6 to a valve or a vacuum pump 5.

In case the controlled atmosphere system 3 is provided with a vacuum pump 5, CO₂ will be removed through the membrane 4 via the pipe 6 and the pump 5 to the surroundings.

When gas is removed from the inside of the container it will be replaced by ambient atmospheric air entering through natural gaps or slots in the container 1, e.g. around the doors thereof or through a valve (not shown).

An aim is to identify parameters in the ripening process acting as suitable trigger points to automate the process.

Suitable trigger points can be O₂ content and/or CO₂ content in the controlled atmosphere, temperature and/or ripening agent dosing.

The invention is related to a method of ripening perishable products during transport in a reefer container or a refrigerated truck or trailer 1, each comprising a controlled atmosphere system 3, which method provides variable ripening time by following steps comprising:
establishing a controlled atmosphere within the container, truck or trailer 1 with ripenable produce loaded 400;
changing temperature in the container, truck or trailer 1 from a temperature where ripenable produce are kept in an unripening controlled atmosphere to a temperature where the ripenable products ripens in controlled atmosphere 401;
dosing ripening agent to the controlled atmosphere in order to initiate ripening while maintaining controlled atmosphere 402;
check if ripening rate is increasing or decreasing and determine ripening status of products by measuring CO₂ respiration rate 403;
when CO₂ respiration rate is rising a ripening model 600 is calibrated using input of timing for ripening start based on scheduled delivery 404;
when a predetermined ripening stage is achieved, the temperature is changed to transport temperature for the ripenable produce 405; and
products are maintained at predetermined ripening stage under controlled atmosphere conditions 406.

An example of the method is illustrated in a flow diagram in FIG. 4.

The predetermined ripening stage can be stage 2-3 in case of the produce being bananas, where ripening stage 2 is green with trace of yellow, stage 3 is more green than yellow.

Respiration rate can be expressed as a function of CO₂ production. When measuring CO₂ concentration, the measuring is carried out inside the container 1 by a CO₂ sensor 7.

The CO₂ production in normal cubic meters per hour can be expressed as (CO₂ concentration (CO₂ %) in the container 1)×(ventilation rate in normal cubic meters per hour) equal to (mass of cargo/produce (bill of loading))×(specific respiration (ml CO₂ per kg per hour).

Checking whether the ripening rate is increasing or decreasing can be done by measuring rise or fall in the CO₂ respiration rate. In case the ripening rate is not increasing or decreasing, the produce is stable. If an increase or decrease in CO₂ respiration rate is measured or detected the ripening status is determined by measuring the accumulated CO₂ respiration rate

According to one embodiment of the method the O₂ content in the container 1 is increased from controlled atmosphere level to 5-21%, preferably 7-10%, before injection of ripening agent.

According to one embodiment of the method the O₂ content in the container 1 is increased for a period of 12-48 hrs. after injection of ripening agent.

According to one embodiment of the method the ripening is started at a predetermined time before scheduled ripening finalization.

Scheduled ripening finalization can in some cases be coincident with scheduled time of delivery.

When using the term “scheduled delivery” it refers to a certain ripened stage on delivery ordered by the customer.

When using the term “scheduled ripening finalization” it refers to a certain ripening stage determined by the shipping company based on scheduled delivery.

In situations where the reefer container is transported from the ship to a yard or warehouse, the container can be without power for shorter or longer periods and in case of longer periods being more than 3 hours, it can be an advantage that the ripening of the produce is finalized when the container is still aboard the ship (still plugged on power).

According to one embodiment of the method, the controlled atmosphere has an O₂ content of 1-10% and a CO₂ content of 0-10%.

According to one embodiment of the method the controlled atmosphere has an O₂ content of 2-5% and a CO₂ content of 3-7%.

According to one embodiment of the method, the specific heat production from the ripenable produce is kept below 300 Watt/ton by controlling the atmosphere within the container, truck or trailer 1 in relation to O₂, CO₂, ripening agent concentration and/or temperature. In another embodiment the specific heat production from the ripenable produce is kept below 200 Watt/ton also by controlling the atmosphere within the container, truck or trailer 1 in relation to O₂, CO₂, ripening agent concentration and/or temperature.

According to one embodiment of the method, the ripening process is controlled on basis of correlations of ripening time, temperature, O₂, CO₂, and ripening agent dosing.

According to one embodiment of the method, ripening process speed is controlled by regulating the O₂ content inside the container atmosphere to achieve a specific CO₂ production or O₂ consumption per mas unit of ripenable produce.

According to one embodiment of the method, the ripening stage is defined from accumulated CO₂ production (or O₂ consumption) per mass unit of ripenable produce during the ripening process.

According to one embodiment of the method, the ripening process is calibrated by input from the time and ripening correlation between maximum respiration rate 21 corresponding to type of ripenable produce and ripening stage of ripenable produce in the container, truck or trailer 1 at that time.

According to one embodiment of the method the ripening stage is monitored using an electronic colour sensor, meassuring colours within an infrared spectrum.

According to one embodiment of the method an amount of chlorophyll and/or amount of beta carotene is meassured using an electronic colour sensor.

It is an advantage if the ripening model 600 can be calibrated and the ripening started under same conditions each time in relation to the load.

Hence to achieve a stable signal, actual CO₂ respiration rate is evaluated against a moving average of CO₂ respiration rate in an interval of between 4 hours and 48 hours, preferably between 12 hours to 24 hours and two times a standard deviation calculated based on readings of CO₂ respiration measured within the last/preceding 12 hours.

When ripening agent is injected and a stable signal for increased respiration rate is detected within the above time intervals, the ripening model 600 is calibrated where an accumulated measuring of CO₂ respiration is started as an integral of the separate ripening model 600 determining the ripening state of products or produce.

Counting of time is started when ripening agent is injected and the actual CO₂ respiration rate is evaluated against a moving average or rolling average of CO₂ respiration rate in an interval of between 4 hours and 48 hours, preferably between 12 hours to 24 hours and exceeding two times a standard deviation calculated based on readings of CO₂ respiration measured within the last/preceding 12 hours.

According to one embodiment of the method, the ripening process is calibrated and/or started when accumulated measured CO₂ respiration rate from the ripenable produce exceed 50% in average taken over last 24 hours.

Hereby it is possible to determine the stage of ripening and adjust the rate of ripening in relation to remaining time to delivery.

According to one embodiment of the method, the ripening process is adjusted based on updated ripening finalization time or the ripenable produce are kept under maintained controlled atmosphere when a predetermined stage of ripening is achieved.

Hereby it is possible to adjust or slow down the rate of ripening in relation to remaining time to delivery.

To control ripening speed the temperature is an effective parameter to control or slow down biological processes in ripenable produce. In case a further reduction of the ripening speed is needed, the amount of oxygen around the ripenable produce can be lowered. This is called CA conditions.

During ripening, the amount of O₂ is more important than the temperature and is therefore used as speed control of the ripening process.

According to one embodiment of the method, the ripening agent is ethylene and/or propylene and/or acetylene.

When produce is loaded or a period of time after produce is loaded into the reefer container 1 the atmosphere within the container is controlled and the produce is kept under controlled atmosphere. One or more sensors 7 measures values of CO₂, O₂ and/or temperature and the values are communicated to a controller 9 being a hardware CPU connected to a memory for controlling the ripening process. Controlling the ripening process is done by correlation of values incorporated in a ripening model 600 taking basis in a ripening baseline 601. Main controlling parameter for controlling the ripening process is production of CO₂. Each specific produce has a certain ripening baseline 601 from where the production of CO₂ can be determined. Having such data stored in the controller 9 or in a memory in communication with the controller 9 it is possible to determine if sensed values of production of CO₂ follows the ripening baseline 601 or if corrections of the controlled atmosphere is necessary for following the ripening model 600 for the specific produce to be ripened.

The controller communicates with the reefer container system and controls parameters such as CO₂ atmosphere 602, O₂ (for example by ventilating) 603, airflow 604, ripening agent dosing control 605 and/or reefer temperature control (heating/cooling) 606.

Hereby the controller 9 changes one or more of the parameters of the container temperature and atmosphere to control where the produce is in the ripening model 600 in relation to the ripening baseline 601.

Results of the controlling can increase or decrease O₂ for example by letting in ambient atmosphere or by supply of O₂, increase or decrease CO₂, purge and/or increase ripening agent, and/or increase or decrease temperature.

Controlling the ripening in controlled atmosphere in a reefer container 1 can as an example be carried out as follows: when the produce is in place in the reefer container 1 and after turning on refrigeration and controlled atmosphere system the CO₂ content in the container is monitored via a sensor 7, and when the CO₂ content shows that it is at a steady state (not rising, not falling), ripening of produce is initiated. In a controller 9 sensed values from the sensors 7 are used to control the ripening process under controlled atmosphere.

When initiating the ripening process, the temperature within the container 1 is increased from transport temperature to ripening temperature and if necessary the atmosphere within the container 1 is dosed with a ripening agent such as ethylene or propylene and/or acetylene.

The ripening process can also be initiated by dosing with a ripening agent followed by increasing temperature within the container 1.

Further the ripening process can be initiated by dosing with a ripening agent and increasing temperature within the container 1 simultaneously.

As an example where the produce is bananas, the transport temperature normally will be in a range between 13.5-14.5° C. and the ripening temperature will be in a range between 14.5-18° C.

In another example where the produce is bananas, the transport temperature normally will be in a range between 12.5-14.5° C. and the ripening temperature will be in a range between 12.5-18° C.

Having bananas of different variaty, lower temperatures may be used. A parameter is to obtain lowest possible transport temperature without having cooling damages.

As an example where the produce is avocados, the transport temperature normally will be in a range between 7-13° C. and the ripening temperature will be in a range between 17-20° C.

As an example where the produce is plums, the transport temperature normally will be in a range between 0-4° C. and the ripening temperature will be in a range between 18-20° C.

As an example where the produce is mangos, the transport temperature normally will be in a range between 10-14° C. and the ripening temperature will be in a range between 16-27° C.

Data for relevant produce are loaded into the controller 9 or the controller communicates with a memory in which data for produces to be transported are stored. Such data are uploaded manually or automatically into the memory of the controller. When preparing the reefer container, truck or trailer for transport of the produce, transport and ripening data will be associated with the relevant produce.

In FIG. 2 a CO₂ production curve for a load of bananas is shown and at 20 of the curve the level of CO₂ generated is at a low steady rate. Here the bananas have not yet entered the ripening process. Bananas can be maintained at this position for a long time.

At 21 the level of CO₂ has greatly increased and the rate of change of generation of CO₂ is at a maximum. This is shown by a steep slope of the CO₂ generation curve and indicates that the ripening process has been initiated.

The ripening process may have been initiated with modifying parameters of the controlled atmosphere. In particular temperature may have been raised and a ripening agent introduced into the atmosphere in the container.

At 22 the CO₂ generation rate is at a maximum but starts to decline. The heat generated at stage 22 is also at a maximum, up to 300 W/ton or more.

At stage 23 the CO₂ generation rate is declining. This indicates that the bananas are suitable for sending to the distribution centre. Ideally the bananas arrive in the yard in this condition so that they can be shipped directly to the distribution centre, but the stage of ripening can also be adapted to a situation where the bananas are to be stored in a period before delivery to or at the distribution centre.

In FIG. 3 also a CO₂ production curve for a load of bananas is shown, but also showing an area 24 below the curve representing the accumulated measured CO₂ respiration rate from a ripenable produce in order to determine the stage of ripening within the container 1 comprising a controlled atmosphere system 3.

In an embodiment of the method shown in FIG. 5 produce is in place in the reefer container and after turning on refrigeration and controlled atmosphere system and running the system in normal controlled atmosphere mode 500 the CO₂ content in the container is monitored 501 via a sensor 7, and when the O₂ content, CO₂ content and temperature are at a steady state (not rising, not falling) 502, ripening of produce is initiated 503. Here the ripening of produce is at stage 20. At ripening start 510 temperature is increased 511, for example to 18C and the atmosphere is dosed with one or more ripening agents 512 and rate of CO₂ respiration 513 is determined followed by calibration/determining ripening start point 514. Here the ripening of produce is at stage 21.

Now the ripening state is checked 520 and rate of CO₂ respiration is checked in relation to a ripening model 521 and the ripening process is controlled 522 by the controller 9 by purging/increasing ripening agent 523, adjusting balance of CO₂/O₂ in the controlled atmosphere 524 and adjusting temperature 525. Followingly end of ripening is determined 526. Here the ripening of produce is at stage 22.

Hereafter normal controlled atmosphere mode is re-entered 530 and temperature is adjusted/decreased 531 and the rate of CO₂ respirations is monitored 521. The ripening of produce is now at stage 23.

In a controller 9 sensed values from the sensors 7 are used to control the ripening process under controlled atmosphere.

When initiating the ripening process, the temperature within the container is increased from transport temperature to ripening temperature and if necessary the atmosphere within the container is dosed with a ripening agent.

Ripening will be initiated by introduction of a ripening agent and increased temperature in relation to transport temperature. The ripening process is calibrated and/or started when the controller detects that the measured CO₂ respiration rate from the ripenable produce reaches a stable signal.

In general the transport temperature can be explained as a temperature being lower than ripening temperature and at which temperature ripening will be kept as low as possible.

In order to achieve a stable signal, actual CO₂ respiration rate is evaluated against a moving average of CO₂ respiration rate in an interval of between 4 hours and 48 hours, preferably between 12 hours to 24 hours and exceeding two times a standard deviation calculated based on readings of CO₂ respiration measured within the last/preceding 12 hours.

When ripening agent is injected and a stable signal for increased respiration rate is detected within the above time intervals and when exceeding two times a standard deviation, the ripening model is calibrated where an accumulated measuring of CO₂ respiration is started as an integral of the separate ripening model determining the ripening state of products or produce.

Counting of time is started when ripening agent is injected and the actual CO₂ respiration rate is evaluated against a moving average or rolling average of CO₂ respiration rate in an interval of between 4 hours and 48 hours, preferably between 12 hours to 24 hours and a standard deviation calculated based on readings of CO₂ respiration measured within the last/preceding 12 hours.

An embodiment of a ripening model is illustrated in a flow diagram in FIG. 7.

Here the ripening model 600 is based on sensor input 700 from real time controlled atmosphere in container, truck or trailer 1. In step 701 Sensor input is used to modify ripening model 600, to provide individual ripening model for a specific container, truck or trailer 1 and specific produce cargo. Ripening model 600 is based on a notional ripening baseline.

In step 702 the controller 9 changes one or more of the parameters of the container, truck or trailer 1 temperature and atmosphere to control where the produce is in the ripening model 600. Output from the controller 9 controls regulation of step 703 increase/decrease O₂ by ventilating to/from the atmosphere; step 704 increase/decrease O₂; step 705 purge/increase ripening agent; and step 706 increase/decrease temperature.

In an aspect the controlled atmosphere system can operated in an on/off mode having a set point of 5% for CO₂. When the system is active and the CO₂ is above the set point the system will bring the CO₂ content down to 5%.

In another aspect the system can have an operating tolerance of 0.3%. This means that when the CO₂ content is above the set point, the system will pull the CO₂ content down to 4.7% and stop. Hereafter ambient atmosphere (comprising 21% O₂) is let into the container and the system will start pulling down the CO₂ content when reaching 5.3% CO₂. The operating gap of the system is hereby 0.6% CO₂.

An example of a controller configured for controlling ripening according to the method is shown in FIG. 6.

By measuring the time for rising the CO₂ content or CO₂ concentration by 0.6% (with no interruptions from the controlled atmosphere system or from supply of fresh air/ambient atmosphere) a figure representing a value for CO₂ production from the load of produce per time unit. When this value is divided with a payload of the container a specific CO₂ production per hour per kg is calculated.

The above calculation can be compensated by a figure/number for free volume within the container. The free volume is space within the container not occupied by the payload or load of produce.

As an example a standard 40 feet reefer container with a volume of 67 m³ and a load of 22.000 kg of bananas having a density of 1, gives a free volume of 67 m³−22 m³=45 m³.

Multiplying the free volume with the production of CO₂ (rise in CO₂ concentration) will give the CO₂ production in normal cubic meters.

In another aspect the above calculation can be calibrated by compensating for leaks in the container.

In FIG. 3 is also indicated a stage 25 before maximum production of mg CO₂ per kg fruit per hour (stage 22) is reached. Here also maximum production of heat is reached. It is therefore an object to control by the controller the ripening process by adjusting the controlled atmosphere to slowing the ripening process by reducing the temperature and modify the controlled atmosphere at a stage 25 before stage 22 is reached.

Hereby the heat production is kept low. One way to control/modify the atmosphere can be by purging.

The above example relates to bananas, but avocados, plums, mangos or all other ripenable produces can be handled correspondingly.

In order to handle ripenable produce according to the methods mentioned above a reefer container or a refrigerated truck or trailer 1 for shipping perishable products such as fruit and vegetables is provided. The container, truck or trailer 1 comprises:
a controlled atmosphere system 3 including sensors 7 capable of measuring at least one of following parameters: temperature, O₂ or CO₂;
a dosing mechanism for dosing ripening agent 8; and
a ripening process controller 9, which controller controls the ripening process based on sensed values of temperature, O₂ and/or CO₂.

Such a system is shown schematically in FIG. 6.

According to one embodiment, the controlled atmosphere system 3 comprises an electronic colour sensor.

According to one embodiment, the controlled atmosphere system 3 comprises a dosing mechanism 8 for dosing ripening agent.

According to one embodiment, the controlled atmosphere system comprises a dosing mechanism 10 for a ripening agent receptor blocking agent.

An example of such a ripening agent receptor blocking agent can be 1-MCP.

According to one embodiment, the controlled atmosphere system comprises a ripening agent removal system 11 comprising photo-catalytic destruction, destruction by ozone or absorption removal.

According to one embodiment, the ripening agent is ethylene and/or propylene and/or acetylene.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense.

The claimed invention is intended to cover all alternatives, modifications and equivalents.

1. A method of ripening perishable products during transport in a structure comprising a controlled atmosphere system, which method provides variable ripening time by the following processes comprising:
establishing a controlled atmosphere within the structure with ripenable produce loaded;
changing a temperature in the structure from a temperature where ripenable produce are kept in an unripening controlled atmosphere to a temperature where the ripenable produce ripens in controlled atmosphere;
dosing a ripening agent to the controlled atmosphere in order to initiate ripening while maintaining controlled atmosphere;
checking if a ripening rate is increasing or decreasing and determining a ripening status of the ripenable produce by measuring a CO₂ respiration rate;
when the CO₂ respiration rate is rising, a ripening model is calibrated using input of timing for a start of ripening based on a scheduled delivery;
when a predetermined ripening stage is achieved, the temperature in the structure is changed to a transport temperature for the ripenable produce; and
maintaining the ripenable produce at the predetermined ripening stage under controlled atmosphere conditions.

2. The method according to claim 1, wherein O₂ content in the structure is increased from a controlled atmosphere level to 5-21% before the dosing of the ripening agent.

3. The method according to claim 2, wherein the O₂ content in the structure is increased for a period of 12-48 hrs. after dosing of the ripening agent.

4. The method according to claim 1, wherein ripening is started at a predetermined time before scheduled ripening finalization.

5. The method according to claim 1, wherein the controlled atmosphere has an O₂ content of 1-10% and a CO₂ content of 0-10%.

6. The method according to claim 1, wherein the controlled atmosphere has an O₂ content of 2-5% and a CO₂ content of 3-7%.

7. The method according to claim 1, further comprising keeping specific heat production from the ripenable produce below 300 Watt/ton by controlling the atmosphere within the structure in relation to O₂, CO₂, ripening agent concentration and/or temperature.

8. The method according to claim 1, wherein ripening of the ripenable produce is controlled on basis of correlations of ripening time, temperature, O₂, CO₂, and ripening agent dosing.

9. The method according to claim 1, wherein the ripening rate is controlled by regulating
O₂ content inside the atmosphere of the structure to achieve a specific CO₂ production or O₂ consumption per mas unit of the ripenable produce.

10. The method according to claim 1, wherein the ripening stage is defined from accumulated CO₂ production per mass unit of ripenable produce during the method.

11. The method according to claim 8, wherein ripening is calibrated by input from a time and ripening correlation between a maximum respiration rate corresponding to type of ripenable produce and ripening stage of ripenable produce in the structure at that time.

12. The method according to claim 8, further comprising monitoring the ripening stage using an electronic color sensor, that measures colors within an infrared spectrum.

13. The method according to claim 8, further comprising measuring an amount of chlorophyll and/or amount of beta carotene using an electronic color sensor.

14. The method according to claim 8, wherein ripening of the ripenable produce is calibrated and/or started when actual CO₂ respiration rate evaluated against a moving average or rolling average of CO₂ respiration rate in an interval of between 4 hours and 48 hours and exceeding two times a standard deviation calculated based on readings of CO₂ respiration measured within the last/preceding 12 hours.

15. The method according to claim 1, wherein ripening of the ripenable produce is adjusted based on an updated ripening finalization time or the ripenable produce are kept under maintained controlled atmosphere when a predetermined stage of ripening is achieved.

16. The method according to one or more of the preceding claims, characterized in that the ripening agent is selected from the group consisting of ethylene, propylene, and acetylene.

17. A structure for shipping perishable products such as fruit and vegetables, which structure comprises:
a controlled atmosphere system comprising a sensor measuring at least one of following parameters: temperature, O₂ or CO₂;
a dosing mechanism that doses ripening agent on perishable products; and
a ripening process controller that (9) controls a ripening process for the perishable products based on sensed values from the sensor of temperature, O₂ and/or CO₂.

18. The structure according to claim 17, further comprising an electronic color sensor.

19. The structure according to claim 17, wherein the controlled atmosphere system comprises a second dosing mechanism that doses ripening agent.

20. The structure according to claim 17, wherein the controlled atmosphere system comprises a second dosing mechanism that doses a ripening agent receptor blocking agent.

21. The structure according to claim 17, wherein the controlled atmosphere system comprises a ripening agent removal system that performs removal of the ripening agent by photo-catalytic destruction, destruction by ozone or absorption removal.

22. The structure according to claim 17, wherein the ripening agent is selected from the group consisting of ethylene, propylene, acetylene.

23. The method according to claim 1, wherein the structure is selected from the group consisting of a reefer container, a refrigerated truck, and a trailer.

24. The method according to claim 2, wherein the O₂ content in the structure is increased from a controlled atmosphere level to 7-10% before the dosing of the ripening agent.

25. The structure according to claim 17, wherein the structure is selected from the group consisting of a reefer container, a refrigerated truck, and a trailer.
